(19) United States
(12) Patent Application Publication
(10) Pub. No.: US 2026/0142220 A1
(43) Pub. Date: May 21, 2026

(54) METHOD FOR MANUFACTURING AT LEAST ONE BATTERY HOUSING PART, BATTERY HOUSING PART, AND DEVICE FOR MANUFACTURING A BATTERY HOUSING PART

(71) Applicant: Nemak, S.A.B. de C.V., García, Nuevo León (MX)

(72) Inventors: Christopher WICKERT, Frankfurt am Main (DE); Stefan MARSCH, Overath (DE)

(21) Appl. No.: 19/482,353

(22) PCT Filed: Apr. 23, 2024
(86) PCT No.: PCT/IB2024/053931

§ 371 Date: Nov. 7, 2025

(30) Foreign Application Priority Data
May 9, 2023 (EP) 23172205.9

(51) Int. Cl. H01M 10/04; H01M 10/613; H01M 10/6556; H01M 50/224; H01M 50/249

(52) U.S. Cl. CPC H01M 10/0481; H01M 10/0404; H01M 10/613; H01M 10/6556; H01M 50/224; H01M 50/249; H01M 2220/20

(57) ABSTRACT

The invention relates to a method for manufacturing at least one battery housing part, in particular a battery tray, for an electrically powered vehicle, comprising the following steps: providing at least one base plate; providing at least one battery housing receptacle for at least partially accommodating at least one battery cell and/or at least one battery module, wherein the at least one battery housing receptacle comprising at least one substantially plate-shaped bottom section, and wherein the substantially plate-shaped bottom section comprises a plurality of channels on a surface; joining the at least one base plate and the at least one battery housing receptacle to each other, wherein the surface of the plate-shaped bottom section of the battery housing receptacle having the plurality of channels faces the base plate. The invention also relates to a battery housing part and a device for manufacturing a battery housing part.

### CROSS-REFERENCE TO RELATED APPLICATIONS

This application claims priority to PCT International Application No. PCT/IB2024/053931 filed on Apr. 23, 2024, which claims priority to European Patent Application No. 23172205.9 filed on May 9, 2023, the entire disclosures of which are expressly incorporated herein by reference.

### STATEMENT RE: FEDERALLY SPONSORED RESEARCH/DEVELOPMENT

Not Applicable.

### BACKGROUND

The present invention relates to a method for manufacturing at least one battery housing part, in particular a battery tray, for an electrically powered vehicle. Furthermore, the present invention relates to a battery housing part, in particular a battery tray, for a vehicle, in particular for an electrically powered vehicle. In addition, the present invention relates to a device for manufacturing a battery housing part, in particular a battery tray, for a vehicle.

Electrically powered vehicles of the type in question here usually carry a plurality of battery modules comprising battery cells, which serve as drive energy storage devices and provide the electrical energy required for driving. In particular, an electrically powered vehicle of the type discussed here is an electric car, which is essentially powered exclusively by one or more electric motors. Alternatively, the aforementioned battery housing part can also be used in a hybrid vehicle, which has a combustion engine in addition to an electric motor.

With regard to driving performance, placing the individual battery modules in the floor area of the vehicle has proven to be effective. To make this possible, battery housing parts have been proposed that are essentially flat and plate-like in design. Such battery housing parts can be arranged in the floor area of the vehicle and connected to the vehicle body.

Accordingly, considerable demands are placed on battery housing parts and battery housings. Battery housing parts, such as a battery tray in particular, should not only support the individual battery modules or battery cells, but also ensure sufficient safety while the vehicle is in operation.

Accordingly, such battery housing parts should, on the one hand, absorb dynamic loads sufficiently and, on the other hand, prevent the individual battery modules or individual battery cells from overheating. In order to dissipate the heat generated during driving, it is known from the prior art to provide the battery housing parts in question with a cooling device that reliably dissipates the heat released during charging and discharging of the battery modules or battery cells.

However, cooling devices arranged in the battery housing parts sometimes lead to complex manufacturing processes for the individual battery housing parts and can also cause adverse dynamic properties during vehicle operation.

Against this background, the present invention is based on the task of specifying a method for manufacturing a battery housing part and a device for manufacturing a battery housing part, which enables simplified and cost-effective manufacture of the battery housing part while providing advantageous mechanical properties and advantageous cooling properties. The present invention also has the task of specifying a battery housing part which has advantageous mechanical properties and advantageous cooling properties.

### BRIEF SUMMARY

According to a first aspect of the present invention, the aforementioned task is solved in a method for manufacturing a battery housing part, in particular a battery tray, for an electrically powered vehicle, in that the method comprises the following steps:
providing at least one base plate;
providing at least one battery housing receptacle for at least partially accommodating at least one battery cell and/or at least one battery module, wherein the at least one battery housing receptacle comprises at least one substantially plate-shaped bottom section and wherein the substantially plate-shaped bottom section comprises a plurality of channels on one surface; and
joining the at least one base plate and the at least one battery housing receptacle to each other, wherein the surface of the plate-shaped bottom section of the battery housing receptacle having the plurality of channels is preferably directed toward the base plate,
pressing the at least one base plate and the at least one battery housing receptacle together by means of at least one pressure pad,
wherein the at least one pressure pad presses the battery housing receptacle, in particular the surface of the plate-shaped bottom section of the battery housing receptacle facing away from the base plate, directly or indirectly against the base plate via a pressing unit.

The above-mentioned method makes it possible to provide a battery housing part, in particular a battery tray, with integrated cooling in a structurally advantageous manner. Joining refers in particular to connecting the battery housing receptacle and the base plate. Preferably, this is a material bond, whereby the material bond is in particular irreversible.

The base plate is preferably an essentially plate-shaped part, in particular an essentially plate-shaped sheet metal. It is also conceivable that only part of the base plate is plate-shaped and another area of the base plate has, for example, a projecting area and/or an angled area. Such an area can be produced, for example, by deep drawing the sheet metal.

The battery housing receptacle serves in particular to enable at least one battery cell and/or at least one battery module to be arranged at least partially in or on the battery housing receptacle. The at least one battery cell and/or the at least one battery module can be arranged both directly and indirectly on or in the battery housing receptacle.

The battery housing receptacle has a substantially plate-shaped bottom section on which the at least one battery cell and/or the at least one battery module can be arranged directly or indirectly. The plate-shaped bottom section can, for example, be provided in the form of a substantially plate-shaped sheet metal. However, the plate-shaped bottom section can also have embossings and/or angled areas.

Preferably, the majority of the channels arranged on the surface of the plate-shaped bottom section are formed by embossed and/or punched sheets or sheet metal parts. Furthermore, it is preferable that the embossed and/or punched metal sheets or metal sheet parts are soldered, in particular oven-soldered, to the plate-shaped bottom section of the battery housing receptacle. This enables a reliable connection and a reliable seal between the majority of channels and the essentially plate-shaped bottom section of the battery housing receptacle, whereby the essentially plate-shaped bottom section with the majority of channels can also be provided cost-effectively on one surface.

It is further preferred that the plurality of channels extend substantially over an entire plate-shaped surface of the plate-shaped bottom section. Alternatively, it is also possible for the plurality of channels to extend only over certain areas of the surface of the plate-shaped bottom section. Preferably, the plurality of channels is arranged on a substantially flat and/or plate-shaped surface of the plate-shaped bottom section of the battery housing receptacle, in particular soldered thereto.

The channels may be open channels in cross-section or closed channels or cooling channels in cross-section. In the present case, a substantially interconnected open channel or a substantially interconnected closed channel may also be regarded as a plurality of open channels or a plurality of closed cooling channels.

The joining of the at least one base plate to the at least one battery housing receptacle may in particular comprise bonding by means of an adhesive and/or foaming by means of a foam material.

The use of at least one pressure pad can provide essentially homogeneous or uniform pressure on the components to be joined, namely the base plate and the battery housing receptacle, so that sufficient joining is ensured, in particular with regard to the plurality of channels provided. In particular, this can counteract the pressures that occur during bonding, which arise, for example, due to a reaction of the adhesive and/or the foam material.

The at least one pressure pad may be formed from a flexible solid material, in particular a soft elastic material such as rubber or silicone. The pressure pad may also be an expandable or inflatable pressure pad, such as a pneumatically inflatable or hydraulically expandable pad, wherein the pad cover may be formed from rubber or silicone, for example. Preferably, a plurality of pressure pads are used in the method, as this contributes to a further improved pressure distribution or force distribution. Furthermore, it is preferable that the at least one pressure pad has a fabric.

The at least one pressure pad presses the battery housing receptacle, in particular the surface of the plate-shaped bottom section of the battery housing receptacle facing away from the base plate, directly or indirectly against the base plate via at least one pressure unit. In particular, the surface of the plate-shaped bottom section of the battery housing receptacle facing away from the bottom plate is subjected directly or indirectly to a pressing pressure and/or a pressing force by means of the at least one pressure pad. Indirect application by means of at least one pressure unit can prove advantageous in that the pressure distribution or force distribution during the pressing step is further improved. Preferably, indirect application is carried out by means of at least one pressure unit. The pressure unit can be, for example, a pressure plate, in particular a metallic pressure plate. Direct application can result in a simpler design, which can reduce the cost of manufacturing the at least one battery housing part.

In a preferred embodiment, the at least one pressure pad can be pressurized and/or filled with compressed air, wherein the applied pressure is indicative of the pressing force exerted by the at least one pressure pad and/or the pressing pressure exerted by the at least one pressure pad. This enables reliable joining, in particular reliable bonding and/or foaming, of the base plate and battery housing receptacle. Preferably, the pressure applied to the at least one pressure pad is adjustable and/or controllable. This enables precise adjustment of the pressing force or pressing pressure exerted, so that advantageous joining between the base plate and the battery housing receptacle can be achieved. Advantageously, the pressure of the at least one pressure pad can be maintained and/or changed during the joining step, so that reliable curing or gelling of an adhesive and/or a foam material can be enabled over a certain period of time. Preferably, the at least one pressure pad is designed to withstand a pressure of up to 18 bar. In particular, it has proven advantageous to provide a pressure of up to 10 bar, in particular up to 6 bar, during the joining step. The aforementioned pressures can provide advantageous locking forces, so that pressure and/or heat developments of the adhesive and/or foam material can be counteracted during a thermoreactive phase of the adhesive and/or foam material.

In a further preferred embodiment, the at least one pressure pad is preferably designed as at least one pressure hose, in particular as at least one fabric pressure hose, and/or the at least one pressure pad, in particular the at least one fabric pressure hose, can be pressurized or filled with tempered air, in particular tempered compressed air. Preferably, the at least one pressure hose has a woven, textile outer shell and a rubberized inner shell. This allows the battery housing receptacles and base plates to be connected in a favorable manner with a material bond using tempered compressed air. For example, a thermal balance can be set that is advantageous in terms of the open time and/or curing time of the foam material and/or adhesive. In particular, this can enable reduced cycle times. The aforementioned pressure hoses also exhibit high flexibility, advantageous rot resistance and maintenance properties, as well as good cold resistance. The aforementioned pressure hoses may in particular be commercially available fire hoses.

It is preferred that the tempered air, in particular the tempered compressed air, has a temperature that is above the ambient temperature. In particular, the tempered compressed air has a temperature of above 25° C., in particular above 35° C., and particularly preferably above 45° C.

It is also preferable that at least one pressure pad is provided, wherein the at least one pressure pad is filled substantially uniformly with compressed air, in particular with heated compressed air, and thus exerts a uniform pressing force on the battery housing receptacle and/or the base plate. This allows pressures and/or heat developments arising during the joining process to be compensated for, which may occur, for example, during the thermoreactive phase of the adhesive and/or the foam material. By operating with heated compressed air, the heating in the lower half of the tool can be supported calorically.

The open time of the foam material and/or adhesive is, in particular, the period of time from the start of application of the foam material and/or adhesive to the joining or bonding of the parts to be joined. The curing time refers in particular to the time during which the final strength of the foam material and/or adhesive is achieved. In this context, it is preferable that the temperature of the battery housing components to be joined, in particular the temperature of the battery housing receptacles, the frames, and/or the base plate, and/or the temperature of the foam material and/or the adhesive is in a range from 25° C. to 55° C., in particular in a range from 27° C. to 50° C., during the process.

Furthermore, it is preferable that the temperature prevailing during the joining process is measured by means of at least one sensor and that the quantity and/or temperature of the tempered air is controlled as a function of the temperature measured by the at least one sensor. This allows the desired temperature to be reliably set during the joining step.

A preferred embodiment is characterized in that, prior to the joining step, a foam material and/or an adhesive is introduced between the at least one base plate and the at least one battery housing receptacle. In particular, the foam material and/or adhesive is introduced between the surface of the plate-shaped bottom section facing the bottom plate and the bottom plate. This enables reliable joining, in particular reliable bonding of the bottom plate and battery housing receptacle during the joining step.

A further preferred embodiment is characterized in that the plurality of channels is designed as a plurality of open channels and that pressing the at least one base plate and the at least one battery housing receptacle together provides a plurality of closed cooling channels. This means that it is sufficient for the battery housing receptacle to have a plurality of open channels at its plate-shaped bottom section, which do not have to be closed in a complex manner in terms of manufacturing technology. The plurality of open channels can then be closed by joining the battery housing receptacle to the base plate, so that the joining creates or provides a plurality of closed cooling channels.

It is preferable that the plurality of open channels is formed in particular by open channels whose cross-section is open to the surface facing away from the plate-shaped bottom section.

Preferably, the at least one base plate is joined to the plurality of channels, in particular connected to them, so that the joining step creates a plurality of channels that are closed in cross-section.

It is preferable that the foam material has recesses in the area of the open channels so that it can be ensured that the open channels or the closed cooling channels are not blocked by the foam material and cooling fluid can be transported reliably.

In a further embodiment, the majority of channels are already provided as essentially closed cooling channels on the battery housing receptacle. This has proven to be particularly advantageous with regard to sealing the cooling channels provided.

A further preferred design is characterized in that the foam material and/or the adhesive is applied to the surface of the plate-shaped bottom section of the at least one battery housing receptacle and/or to the bottom plate, which has the majority of channels. The foam material and/or adhesive can provide a mass that, on the one hand, can ensure sufficient sealing and, on the other hand, also ensures a sufficient connection between the at least one battery housing receptacle and the at least one base plate. The foam material and/or adhesive can also be advantageous in terms of insulation and can improve the crash properties of the battery housing part by dissipating forces at the underside of the vehicle in the event of an accident.

In particular, it is preferable that, in the case of the formation of the plurality of channels as a plurality of open channels, the foam material and/or the adhesive is applied essentially only to the walls and/or ribs delimiting the open channels and/or those areas of the plate-shaped bottom section which do not have open channels. This is particularly advantageous in that the cooling channels formed by the base plate and the open channels are then not or only slightly blocked by the foam material and/or the adhesive and can therefore provide sufficient cooling capacity during the intended operation of the at least one battery housing part.

In a further embodiment concerning the design of the plurality of channels as open channels, it is preferred that, when joining the at least one base plate and the at least one battery housing receptacle to each other and/or during the joining step, a counterforce, for example pneumatic pressure, is generated at least partially within the open channels and/or the cooling channels closed during the joining step, so that the foam material and/or the adhesive does not substantially close and/or block the open channels and/or the closed cooling channels. This ensures sufficient cooling performance and sufficient cooling flow in the closed cooling channels during the intended operation of the battery housing part.

A further preferred embodiment is characterized in that the foam material and/or the adhesive comprises a multi-component system, in particular a two-component system, or is designed as a multi-component system, in particular as a two-component system. The multi-component system, in particular the two-component system, can consist of two different materials or comprise two different materials that can be mixed in a specific ratio to trigger a chemical reaction that leads to curing or cross-linking.

For example, the multi-component system may be a resin-hardener combination, wherein the resin may be a liquid, reactive component and the hardener may be a solid or liquid component that triggers a chemical reaction when mixed with the resin. The resin and hardener are preferably chemically inert and stable until they are mixed. After mixing, the multi-component system can then cure quickly, robustly, and reliably, thus providing the aforementioned functional properties of the foam material and/or adhesive.

It is also preferable that the multi-component system, in particular the two-component system, is mixed essentially immediately before the foam material is introduced between the at least one base plate and the at least one battery housing receptacle. This allows a corresponding reaction of the multi-component system to occur only during the joining step, which leads to the advantageous properties of the multi-component system during the joining step, in particular contributes to advantageous mechanical properties of the at least one battery housing part and preferably leads to an advantageous connection between the battery housing receptacle and the base plate. Preferably, the multi-component system is mixed in a mixer and then applied to the at least one battery housing receptacle. The use of multi-component systems, in particular two-component systems, is advantageous over single-component systems because mixing the components causes a chemical reaction that strengthens the bond between the two joining partners, whereas a single-component system, for example, requires additional heating.

A further preferred embodiment is characterized in that the method further comprises: providing at least one frame, in particular a steel frame, which at least partially surrounds the at least one battery housing part, and joining the frame to the base plate and the battery housing receptacle. It is preferred that the frame is first joined to the battery housing receptacle, in particular connected to the battery housing receptacle. The frame can then be joined, in particular connected, to the base plate. Such a frame enables, in particular, an advantageous connection of the at least one battery housing part to the vehicle and can also improve the mechanical properties of the at least one battery housing part or the battery tray or the entire battery housing.

In a further preferred embodiment, the at least one battery housing receptacle has essentially plate-shaped side walls adjoining the at least one essentially plate-shaped base section. Such side walls can surround the at least one essentially plate-shaped bottom section on all sides in particular and thus, together with the plate-shaped bottom section, define a receiving space for the at least one battery module and/or the at least one battery cell. This can enable a reliable arrangement of the battery cells and/or battery modules within the battery housing receptacle.

A further preferred embodiment is characterized in that the at least one battery housing receptacle preferably has fastening sections adjoining the side walls, wherein the fastening sections extend in particular substantially parallel to the substantially plate-shaped bottom section and can be designed, for example, as a circumferential collar. By means of such fastening sections, the at least one battery housing part and/or the battery housing receptacle can be reliably connected to a vehicle and/or to a frame, in particular to a battery frame.

Furthermore, it is preferable that the essentially plate-shaped side walls are connected and/or sealed and/or cast to the at least one frame by means of a sealing agent or a casting agent, in particular by means of a polyurethane sealing agent or a polyurethane casting agent. Preferably, such bonding and/or sealing takes place before the joining step in which the at least one base plate and the at least one battery housing receptacle are joined. Furthermore, it is preferable that the sealing agent and/or the casting agent is only applied once the at least one frame has already been bonded and/or clamped to the at least one battery housing receptacle. In such a case, the joint gap to be sealed or potted is first measured, then the filling quantity is determined in the individual areas, and then the sealing agent and/or potting compound is applied. Such a sealing agent and/or potting compound can, for example, prevent unwanted liquid from entering the battery housing receptacle. In addition, the use of a sealing agent and/or a casting agent can be advantageous with regard to the insulating properties of the at least one battery housing part. The sealing agent and/or the casting agent can also be, for example, a foam material, in particular 2K polyurethane.

A further preferred embodiment is characterized in that the fastening sections are bonded to the at least one frame and/or that the at least one base plate is bonded to the frame. Preferably, the fastening sections are first bonded to the frame at least partially surrounding the battery housing receptacle, whereupon, preferably as part of the joining step of the battery housing receptacle and base plate, the frame is bonded and/or joined to the base plate. This allows advantageous mechanical properties of the at least one battery housing part to be provided.

According to a second aspect of the present invention, the aforementioned task is solved by a battery housing part for an electrically powered vehicle, wherein the battery housing part comprises: at least one battery housing receptacle for at least partially accommodating at least one battery cell and/or at least one battery module, and at least one base plate connected to the at least one battery housing receptacle, wherein a plurality of closed cooling channels are arranged between the at least one battery housing receptacle, in particular a substantially plate-shaped bottom section of the at least one battery housing receptacle, and the at least one base plate, wherein the battery housing part is designed according to a method according to the first aspect of the invention.

The aforementioned task is solved according to a third aspect of the present invention by a device for manufacturing a battery housing part, in particular a battery tray, for an electrically powered vehicle, comprising: at least one upper and movable tool half for fixing and manipulating at least one base plate; at least one lower tool half comprising at least one pressure unit and at least one pressure pad for joining the at least one base plate and a battery housing receptacle; wherein the at least one battery housing receptacle comprises at least one substantially plate-shaped bottom section and wherein the substantially plate-shaped bottom section comprises a plurality of channels on one surface, characterized in that the device further comprises at least one heating means so that the at least one pressure pad can be supplied with or filled with tempered air, in particular tempered compressed air. The advantages associated with such a device have already been described above in connection with a method according to the first aspect.

Preferably, the upper tool half fixes the base plate via a vacuum unit so that it can be advantageously aligned and fixed. To position the base plate and the battery housing receptacle provided with foam material and/or adhesive, the upper tool half can be moved, in particular hydraulically, until the base plate held by the upper tool half essentially rests against the battery housing receptacle. A corresponding position can then be locked in place mechanically, for example, using bolts. For example, the base plate and the battery housing receptacle connected to the frame can also be locked in place hydraulically. The pressure required for the further joining process can then be provided by the at least one pressure pad.

Furthermore, it is preferable that the at least one pressure pad be filled with tempered air, whereby a pressing pressure can build up uniformly and at a controlled temperature to counteract the pressure of the adhesive and/or the foam material. Appropriate temperature control can reduce the cycle time of the joining process and also enable essentially robust parameters of the joining process, independent of the ambient temperature. The tempered air, in particular the tempered compressed air, can be heated or cooled air, for example. In addition, the tempered air can be used to set a uniform temperature profile in the tool, which prevents distortion of the components to be joined, so that manufacturing tolerances can be reliably maintained.

Preferably, the upper tool half is first pivoted, for example by means of at least one hinge attachment. When a minimum distance between the base plate to be joined and the battery housing receptacle is reached, the upper tool half is then moved essentially vertically and/or linearly. In particular, the upper tool half is moved in such a way that the at least one base plate and the at least one battery housing receptacle are moved toward each other in a plane-parallel manner. This advantageously prevents shearing of the connection between the battery housing receptacle, frame, and/or base plate. Such a design has also proven advantageous in that the air remaining in the device can be minimized, further improving the joining process of the base plate and battery housing receptacle.

After the essentially vertical, linear, and/or plane-parallel movement of the upper tool half, it is placed on a locking device and/or locked by means of a locking device. For example, this may be a hydraulic and/or mechanical locking device.

It is preferred that the device is designed to perform a method according to the first aspect.

The embodiments and exemplary configurations of all aspects of the present invention described above, which are initially fundamentally independent of each other, should also be understood to be disclosed in all combinations with each other.

Further advantageous exemplary embodiments of the invention can be seen in the following detailed description of some exemplary embodiments of the present invention, in particular in conjunction with the figures. However, the figures accompanying the application are intended only for the purpose of clarification and not for determining the scope of protection of the invention. The accompanying drawings are not necessarily to scale and are intended only to reflect the general concept of the present invention by way of example. In particular, features included in the figures should in no way be considered an essential part of the present invention.

### BRIEF DESCRIPTION OF THE DRAWINGS

The invention is explained in more detail below with reference to drawings showing examples of embodiments. Each of the following shows schematically:

FIG. 1 a schematic view of a method for manufacturing a first embodiment of a battery housing part;

FIG. 2 a schematic view of a first embodiment of a battery housing part manufactured by the method; and

FIG. 3 a schematic view of a method for manufacturing a second embodiment of a battery housing part.

### DETAILED DESCRIPTION

In the following description of the various embodiments according to the invention, components and elements with the same function and the same mode of operation are assigned the same reference numerals, even if the components and elements may differ in their dimensions or shape in the various embodiments.

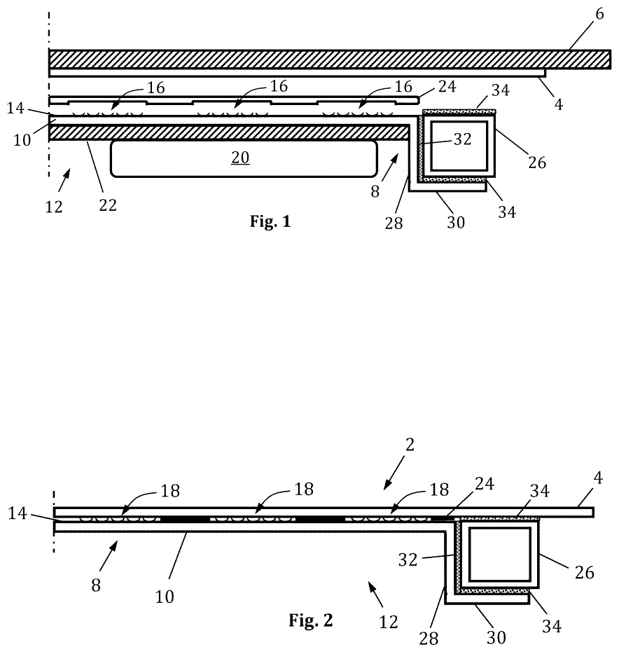

FIGS. 1 and 2 show a schematic view of a method for manufacturing at least a first embodiment of a battery housing part 2 and a first embodiment of a battery housing part 2 manufactured using the method, respectively. In the aforementioned method, a base plate 4 is provided by means of a first, preferably movable upper tool half 6. A battery housing receptacle 8 is also provided, which serves to accommodate at least one battery cell and/or at least one battery module.

The battery housing receptacle 8 has a substantially horizontally extending, plate-shaped base section 10, which has a plurality of open channels 16 on its surface 14 facing away from a receptacle space 12 for the battery modules and/or battery cells.

When the base plate 4 and the battery housing receptacle 8 are joined, the open channels are then closed by means of the base plate 4, so that closed cooling channels 18 are provided (see FIG. 2).

During joining, the battery housing receptacle 8 is preferably pressed against the base plate 4 by means of at least one pressure pad 20 or a plurality of pressure pads 20. In this case, the at least one pressure pad 20 does not exert pressure on the battery housing receptacle 8 directly, but rather by means of a pressure unit 22 or a second tool half. The at least one pressure pad 20 can be pressurized with pressure or air, whereby the pressure is indicative of the pressing force or pressing pressure exerted by the at least one pressure pad 20. The amount of pressure applied to the at least one pressure pad 20 is adjustable and/or controllable and can be maintained or adjusted during the joining step. Preferably, the compressed air is temperature-controlled so that the at least one pressure pad 20 can enable temperature control during the joining step. The use of at least one pressure pad 20 designed as a fabric hose has proven advantageous in practice in terms of sufficient heating and desired force distribution.

Before the joining step of the battery housing receptacle 8 and the base plate 4, a foam material 24 can be inserted between the base plate 4 and the battery housing receptacle 8, which serves in particular to improve the mechanical properties of the battery housing part 2 and to improve the connection between the base plate 4 and the battery housing receptacle 8. For example, less foam material 24 can be inserted into the areas of the open channels 16 so that the open channels 16 or the cooling channels 18, which are closed after joining, do not become clogged and sufficient cooling fluid can flow through the closed cooling channels 18 (see FIG. 1). Similarly, for example, no foam material 24 can be placed in the areas of the open channels 16, so that correspondingly no foam material 24 is placed in the areas of the closed cooling channels 18 (see FIG. 2).

For example, the battery housing part 2 may have a frame 26 that at least partially surrounds the battery housing part 2. The frame 26 is first connected to the battery housing receptacle 8, for example. For this purpose, the battery housing receptacle 8 preferably has side walls 28 adjoining the plate-shaped bottom section 10 and fastening sections 30 adjoining the side walls 28. The plate-shaped side walls 28 are sealed or cast and/or connected to the frame 26, for example, by means of a polyurethane sealing agent 32, in particular with a 2 k polyurethane casting compound.

The fastening sections 30 are also bonded to the frame 26 on their surfaces facing the frame 26, for example by means of adhesive 34. Adhesive 34 may also be applied to one side surface of the frame 26, whereby the frame 26 can be bonded to the base plate 4 by means of the adhesive.

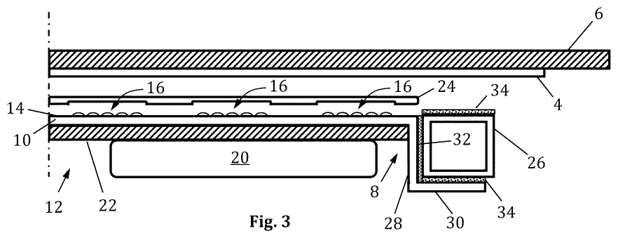

FIG. 3 shows a schematic view of a method for manufacturing a second embodiment of a battery housing part 2. In contrast to the first embodiment of the battery housing part 2 shown in FIGS. 1 and 2, the channels 16 on the surface of the plate-shaped bottom section 10 are already provided as closed cooling channels 18, so that the closed cooling channels 18 are not created by joining the bottom plate 4 and the battery housing receptacle 8. This improves the tightness of the closed cooling channels 18.

The exemplary embodiments/examples of the present invention described in this specification are to be understood as disclosed both individually and in all combinations with each other. In particular, unless explicitly stated otherwise, the description of a feature included in an embodiment should not be understood to mean that the feature is indispensable or essential for the function of the embodiment. The sequence of the process steps described in this specification is not mandatory; alternative sequences of the process steps are conceivable. The process steps can be implemented in various ways; for example, implementation in software (through program instructions), hardware, or a combination of both is conceivable for implementing the process steps.

Terms used in the patent claims such as “comprise,” “have,” “include,” “contain,” and the like do not exclude further elements or steps. The phrase “at least partially” covers both the case of “partially” and the case of “completely.” The phrase “and/or” should be understood to mean that both the alternative and the combination should be disclosed, i.e., “A and/or B” means “(A) or (B) or (A and B)”. A plurality of units, persons, or the like means, in the context of this specification, multiple units, persons, or the like. The use of the indefinite article does not exclude a plurality. A single device may perform the functions of several units or devices mentioned in the patent claims. Reference signs specified in the patent claims are not to be regarded as limitations on the means and steps used.

### Reference Sign List

2 Battery housing part
4 Base plate
6 Upper tool half
8 Battery housing receptacle
10 Plate-shaped bottom section
12 Holding space
14 Surface of the plate-shaped bottom section with channels
16 Channels
18 Closed cooling channels
20 Pressure pads
22 Pressure unit
24 Foam material
26 Frame
28 Side wall
30 Fastening section
32 Sealing agent
34 Adhesive

1-15. (canceled)

16. A method for manufacturing a battery tray for an electrically powered vehicle, the method comprising the steps of:
providing a base plate;
providing a battery housing receptable for at least partially accommodating at least one battery cell or at least one battery module, the battery housing receptable comprising a substantially planar base portion, the substantially planar base portion comprising a first surface having a plurality of channels arranged thereupon, and a second surface opposed thereto;
joining the base plate and battery housing receptacle such that the surface of the plate-shaped bottom section having the plurality of channels arranged thereupon is aligned with the base plate; and
applying pressure against at least the second surface of the substantially planar bottom portion to cause the first surface of the substantially planar bottom portion having a plurality of channels arranged thereupon to be pressed against the base plate;
wherein the application of pressure is achieved at least via pressurization of a pressure pad

17. The method of claim 16, wherein the pressure pad is operative to apply an adjustable level of pressure.

18. The method of claim 16, wherein the pressure pad comprises a fabric pressure hose.

19. The method of claim 18, wherein the pressure hose is configured to be pressurized with temperature-controlled air.

20. The method of claim 16, wherein a foam material is applied between the base plate and the battery housing receptacle prior to the joining step.

21. The method of claim 20, wherein the foam material is applied to the first surface of the substantially planar base portion having a plurality of channels arranged thereupon.

22. The method of claim 16, wherein the plurality of channels arranged on the first surface of the substantially planar bottom portion are open channels, and wherein the step of applying pressure results in the formation of a plurality of closed cooling channels.

23. The method of claim 22, wherein the plurality of channels arranged on the first surface of the substantially planar bottom portion are delimited by a plurality of walls or ribs, and wherein prior to the joining step, a foam material is applied substantially only to the walls or ribs delimiting the plurality of channels such that during the joining step, the foam material does not substantially occlude the resulting closed cooling channels.

24. The method of claim 22, wherein prior to the joining step, a foam material is applied to the first surface of the substantially planar base portion having a plurality of channels arranged thereupon, and wherein during the joining step, pneumatic pressure is applied within the channels so as to prevent the foam material from substantially occluding the resulting closed cooling channels.

25. The method of claim 20, wherein the foam material comprises a multi-component system, and wherein the multi-component system is mixed immediately prior to the application of the foam material between the base plate and the battery housing receptacle.

26. The method of claim 16, further comprising the steps of providing a frame, and connecting the frame to the base plate and to the battery housing receptacle.

27. The method of claim 16, wherein the battery housing receptacle further comprises:
a plurality of side walls adjoining the substantially planar base portion; and
a plurality of fastening sections, each fastening section adjoining at least one side wall, each of the plurality of fastening sections extending in a substantially parallel direction to the substantially planar base portion.

28. The method of claim 26, wherein the battery housing receptacle further comprises a plurality of side walls, and wherein the step of connecting the frame to the battery housing receptacle comprises application of a polyurethane sealing agent.

29. The method of claim 26, the step of connecting the frame to the battery housing receptacle and to the base plate comprises adhesive bonding.

30. A battery tray for an electrically powered vehicle produced by the method comprising the steps of:
providing a base plate;
providing a battery housing receptable for at least partially accommodating at least one battery cell or at least one battery module, the at least one battery housing receptable comprising at least one substantially planar base portion, the substantially planar base portion comprising a first surface having a plurality of channels arranged thereupon, and a second surface opposed thereto;
joining the base plate and battery housing receptacle such that the surface of the plate-shaped bottom section having the plurality of channels arranged thereupon is aligned with the base plate; and
applying pressure against at least the second surface of the substantially planar bottom portion to cause the first surface of the substantially planar bottom portion having a plurality of channels arranged thereupon to be pressed against the base plate;
wherein the application of pressure is achieved at least via pressurization of a pressure pad

31. A device for manufacturing a battery tray for an electrically powered vehicle comprising:
at least one upper, movable, tool half operable to fix in place and manipulate a base plate; and
at least one lower tool half comprising at least one pressure unit and at least one pressure pad, the lower tool half being operable to join together a base plate and a battery housing receptacle, the battery housing receptacle comprising a substantially planar base portion with a first surface having a plurality of channels arranged thereupon; and
wherein the heating pad is configured to receive temperature-controlled compressed air.
